(19) United States
(12) Patent Application Publication
(10) Pub. No.: US 2002/0180754 A1
(43) Pub. Date: Dec. 5, 2002

(54) Display device and display panel driving method

(75) Inventor: Masahiro Suzuki, Nakakoma-gun (JP)

Correspondence Address: SUGHRUE MION, PLLC, 2100 PENNSYLVANIA AVENUE, N.W., WASHINGTON, DC, 20037, US

(73) Assignee: PIONEER CORPORATION and SHIZUOKA PIONEER CORPORATION

(21) Appl. No.: 10/153,789

(22) Filed: May 24, 2002

(30) Foreign Application Priority Data
May 30, 2001 (JP) 2001-161994

(51) Int. Cl. G09G 5/02

(52) U.S. Cl. 345/598

(57) ABSTRACT

The present invention relates to a display device that has a good-quality image display while suppressing dither patterns which arise upon the execution of dither processing. The values of dither coefficients allocated to the display cells which emit at least one color within pixels are made different from the values of dither coefficients allocated to other display cells which emit another color within the pixels.

### BACKGROUND OF THE INVENTION

1. Field of the Invention

This invention relates to a display device having display cells arranged in a matrix.

2. Description of the Related Art

In recent times, plasma display panels (hereinafter referred to as “PDPs”), in which a plurality of discharge cells serving as pixels are arranged in a matrix, have attracted attention as two-dimensional image display panels. PDPs are directly driven by digital image signals, and the number of brightness grayscales which can be represented is determined by the number of bits of pixel data for each pixel, based on the above digital image signal. The subfield method, in which the display period of one field is divided into a plurality of subfields for driving, is known as one method of PDP grayscale driving. For example, when there are 8 bits of pixel data, the display period of one field is divided, into eight subfields, SF8, SF7, . . . , SF1, in order of weighting. Each subfield includes an address period, which sets the lit pixel state or the extinguished pixel state for each pixel according to the pixel data, and an emission sustain period which causes only pixels in the above lit pixel state to emit for a period corresponding to the weighting for that subfield. In other words, for each subfield, discharge cells are set to either light or not light within that subfield (the address period), and only those discharge cells set in the lit state are caused to emit for the period allocated for that subfield (emission sustain period). Hence there occur cases in which, within one field, there are intermixed subfields in the lit state and subfields in the extinguished state; and intermediate brightnesses corresponding to the sum total of the emission period for each subfield are perceived.

In display devices adopting PDPs, the number of perceived grayscales can be increased and image quality improved by employing dither processing in such grayscale driving.

In dither processing, for example, four neighboring pixels above and below, and left and right, are treated as one set, and four dither coefficients consisting of different coefficient values (for example, 0, 1, 2, 3) are added to the four pixel data corresponding to the four pixels of this set respectively. Here, when the above four pixels are treated as one pixel, dither processing increases the apparent number of grayscales.

However, if dither coefficients are added to pixel data in this way, so-called dither patterns, which are pseudo-patterns unrelated to the original pixel data, are sometimes perceived. Consequently there is the problem that image quality is degraded.

### SUMMARY OF THE INVENTION

An object of the present invention is to provide a display device capable of presenting good-quality image display in which dither patterns are suppressed.

According to one aspect of the present invention, there is provided a display device for displaying an image, in response to an image (video) signal, on a display screen, in which display screen each of pixels includes a plurality of display cells with different emission colors and the, pixels are arranged in a matrix, the display device comprising: means for converting the image signal into the pixel data such that each of the pixel data corresponds to each of the display cells; dither coefficient generation means for generating dither coefficients such that each of the dither coefficients corresponds to each of the display cells within the pixel; addition means for adding the dither coefficients to the pixel data to obtain dither-added pixel data; and display driving means for causing emission of the display cells in accordance with the dither-added pixel data. A value of the dither coefficient corresponding to a display cell used for emission of (at least) one color within the pixel is set to be different from values of other dither coefficients corresponding to other display cells used for emission of other colors within the pixel.

The dither coefficients added to the pixel data to drive display cells responsible for at least one display color are different in value from the dither coefficients added to the pixel data to drive display cells responsible for another display color. Hence a specific dither pattern is no longer visually recognized in a screen. Consequently good-quality image display is obtained, with the occurrence of dither patterns suppressed.

### BRIEF DESCRIPTION OF THE ACCOMPANYING DRAWINGS

FIG. 1 schematically illustrates the configuration of a plasma display device, as a display device according to one embodiment of the present invention;

FIG. 2 illustrates the internal configuration of the data conversion circuit used in the plasma display device shown in FIG. 1;

FIG. 3 shows the internal configuration of the ABL circuit shown in FIG. 2;

FIG. 4 is diagram showing the conversion characteristic of the data conversion circuit shown in FIG. 3;

FIG. 5 is a diagram showing the data conversion characteristic of the first data conversion circuit shown in FIG. 2;

FIG. 6 is a diagram showing the conversion table of the second data conversion circuit shown in FIG. 2, together with an emission driving pattern;

FIG. 7 shows the emission driving format of the plasma display device shown in FIG. 1;

FIG. 8 shows various driving pulses applied to the PDP within one field, and the application timing thereof;

FIG. 9 shows the internal configuration of the multi-grayscale circuit shown in FIG. 2;

FIG. 10 shows the arrangement of pixels in the PDP, and the red discharge cells C_{R}, green discharge cells C_{G}, and blue discharge cells C_{B} within individual pixels;

FIG. 11A shows one example of dither coefficients generated by the dither matrix circuit;

FIG. 11B shows another example of the dither coefficients generated by the dither matrix-circuit;

FIG. 12 shows a digit-carry pattern, from the lower four bits to the upper four bits, resulting from addition of dither coefficients shown in FIG. 11A, and the dither pattern perceived as a result of this digit-carry pattern; and,

FIG. 13 shows a digit-carry pattern, from the lower four bits to the upper four bits, arising from addition of dither coefficients shown in FIG. 11B, and the dither pattern perceived as a result of this digit-carry pattern.

### DETAILED DESCRIPTION OF THE INVENTION

Embodiments of the present invention will be described in reference to the accompanying drawings.

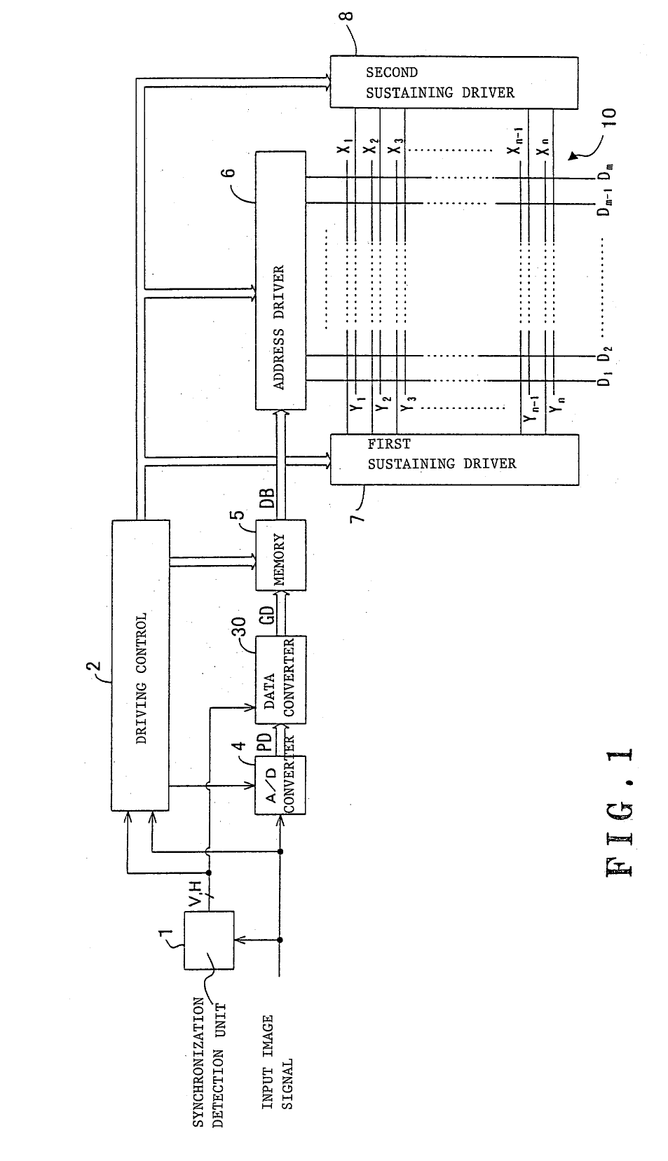

Referring to FIG. 1, a configuration of a display device of one embodiment of the present invention is illustrated.

The display device shown in FIG. 1 is a plasma display device equipped with a plasma display panel as a display device. This display device includes a PDP 10 as the plasma display panel, and a driving unit. The drive unit includes synchronization detection circuit 1, driving control circuit 2, A/D converter 4, data conversion circuit 30, memory 5, address driver 6, first sustaining driver 7, and second sustaining driver 8.

The PDP 10 includes column electrodes D₁ to Dₘ as address electrodes, and row electrodes X₁ to Xₙ and row electrodes Y₁ to Yₙ arranged perpendicularly to the column electrodes. In the PDP 10, row electrodes corresponding to one display line worth is formed from a pair of the row electrode X and row electrode Y. Column electrodes D₁ to Dₘ are divided into column electrodes D₁, D₄, D₇, . . . , Dₘ₋₂, which handle red emission; column electrodes D₂, D₅, D₈, . . . , Dₘ₋₁, which handle green emission; and column electrodes D₃, D₆, D₉, Dₘ, which handle blue emission. Red discharge cells which emit red light on discharge are formed at each of the intersections of the column electrodes D₁, D₄, D₇, . . . , Dₘ₋₂, which handle red emission, and the row electrodes X and Y. Green discharge cells which emit green light on discharge are formed at each of the intersections of the column electrodes D₂, D₅, D₈, . . . , Dₘ₋₁, which handle green emission, and the row electrodes X and Y. Blue discharge cells which emit blue light on discharge are formed at each of the intersections of the column electrodes D₃, D₆, D₉, . . . , Dₘ, which handle blue emission, and the row electrodes X and Y. Here, one pixel is formed from three discharge cells neighboring in the display line direction, that is, from a red discharge cell, green discharge cell, and blue discharge cell.

The synchronization detection circuit 1 generates a vertical sync signal V when a vertical sync signal is detected in the analog image signal. Also, the synchronization detection circuit 1 generates a horizontal sync signal H when a horizontal sync signal is detected in the image signal. The synchronization detection circuit 1 supplies these vertical sync signals V and horizontal sync signals H to the driving control circuit 2 and data conversion circuit 30. The A/D converter 4 samples the image signal in response to a clock signal supplied by the driving control circuit 2, converts the sampled signal(s) into pixel data PD with, for example, 8 bits for each pixel, and supplies the resulting data to the data conversion circuit 30.

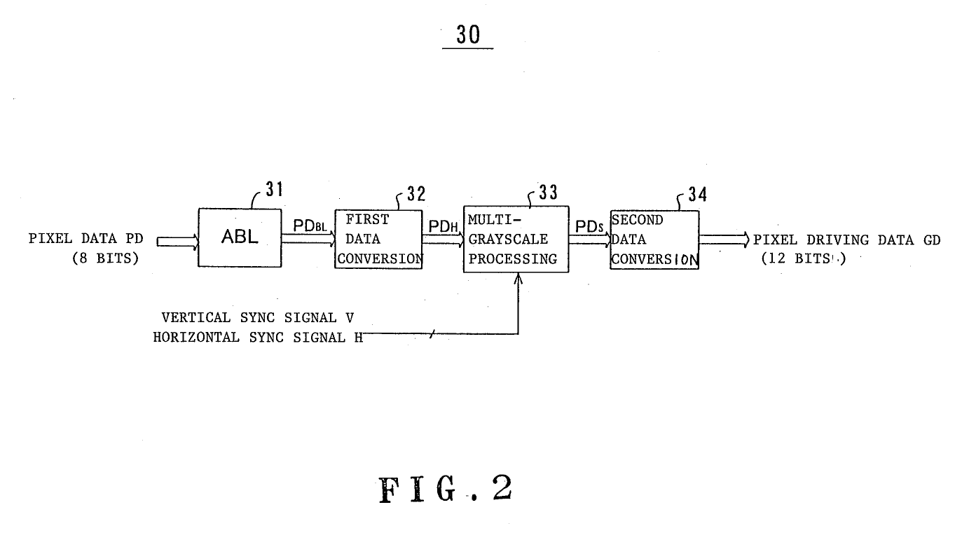

FIG. 2 shows the internal configuration of the data conversion circuit 30.

As shown in FIG. 2, the data conversion circuit 30 includes an ABL (automatic brightness control) circuit 31, first data conversion circuit 32, multi-grayscale processing circuit 33, and second data conversion circuit 34.

The ABL circuit 31 adjusts the brightness level of the pixel data PD for each pixel supplied in sequence from the A/D converter 4, such that the average brightness of the image displayed on the screen of the PDP 10 is within an appropriate brightness range, and supplies the brightness-adjusted pixel data PD_{BL} obtained in this way to the first data conversion circuit 32.

FIG. 3 shows the internal configuration of the ABL circuit 31.

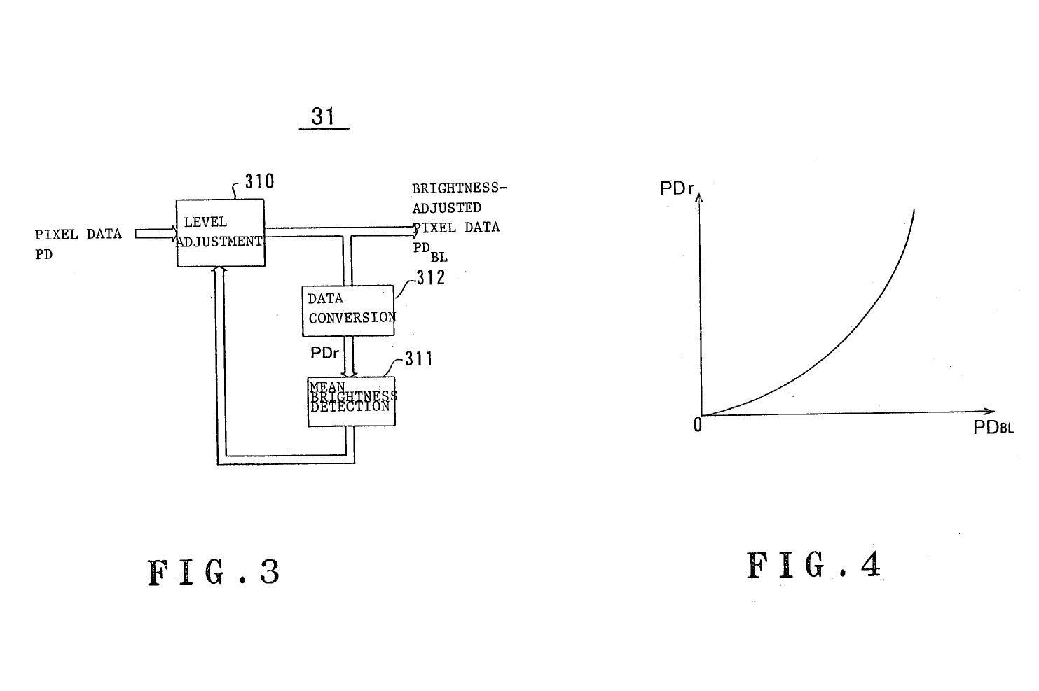

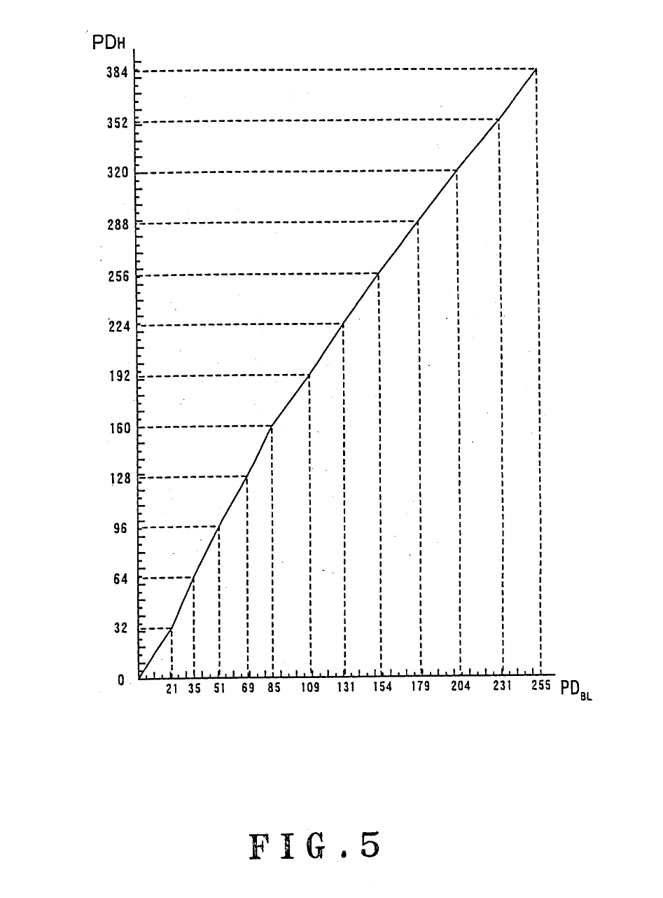

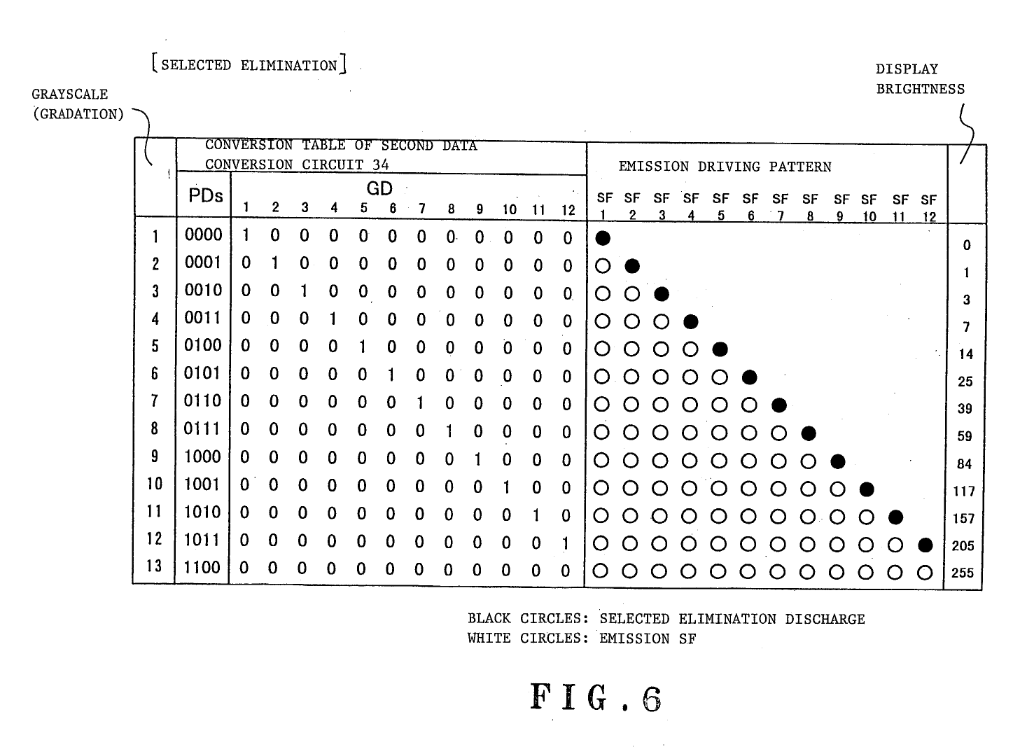

In FIG. 3, the level adjustment circuit 310 outputs brightness-adjusted pixel data PD_{BL} obtained by adjusting the level of the pixel data PD in accordance with the mean brightness determined by the mean brightness detection circuit 311 (will be described). The data conversion circuit 312 supplies, to the mean brightness level detection circuit 311, the result of converting this brightness-adjusted pixel data PD_{BL} from a nonlinear characteristic (as shown in FIG. 4) to an inverse-gamma characteristic (Y=X^{2.2}), as inverse-gamma converted pixel data PDr. That is, by subjecting the brightness-adjusted pixel data PD_{BL} to inverse-gamma correction processing, pixel data (inverse-gamma converted pixel data PDr) corresponding to the original image signal with gamma correction canceled is restored. The mean brightness detection circuit 311 determines the mean brightness of this inverse-gamma converted pixel data PDr, and supplies the level adjustment circuit 310 with mean brightness information indicating this mean brightness. The level adjustment circuit 310 supplies pixel data PD with the level adjusted according to this mean brightness information to the data conversion circuit 312 and to the first data conversion circuit 32 of the next stage, as the brightness-adjusted pixel data PD_{BL}. The first data conversion circuit 32 converts the brightness-adjusted pixel data PD_{BL} to 9 bits, from “0” to “384” of first conversion pixel data PD_{H}, based on conversion characteristics as shown in FIG. 5, and supplies the resultant to the multi-grayscale processing circuit 33. The first data conversion circuit 32 performs data conversion according to the number of display grayscales in the multi-grayscale processing circuit 33 (will be described) and the number of compression bits in multi-grayscale processing. That is, brightness saturation due to the multi-grayscale processing of the multi-grayscale processing circuit 33, and the occurrence of flat portions in the display characteristic arising when display grayscales are not at bit boundaries (that is, the occurrence of grayscale distortion), are prevented.

The multi-grayscale processing circuit 33 subjects the above 9 bits of first converted pixel data PD_{H} to error-diffusion processing and dither processing (will be described), and by this means generates multi-grayscale-processed pixel data PD_{S} with the number of grayscales maintained, but with the number of bits reduced to 4. This error-diffusion processing and dither processing are described below. The second data conversion circuit 34 converts the above 4 bits of multi-grayscale-processed pixel data PD_{S} into pixel driving data GD including first through 12th bits, according to a conversion table as shown in FIG. 6. Each of these first through 12th bits corresponds to subfields SF1 to SF12 (will be described).

In this way, by means of the multi-grayscale processing circuit 33 and second data conversion circuit 34, pixel data PD which can represent 256 grayscales using 8 bits is converted into 12-bit pixel driving data GD including, in all, 13 patterns, as shown in FIG. 6.

The memory 5 sequentially writes and stores the pixel driving data GD according to write signals supplied from the driving control circuit 2. When, in this write operation, writing of one screen's worth (n rows, m columns) of pixel driving data GD₁₁ to GDₙₘ ends, the memory 5 sequentially reads and supplies to the address driver 6 one row's worth (one display line worth) of bits in the same digit (bit place) of the pixel driving data GD₁₁ to GDₙₘ, in response to a read signal supplied from the driving control circuit 2. That is, the memory 5 divides one screen's worth of pixel driving data GD₁₁ to GDₙₘ, each comprising 12 bits, to be handled as pixel driving data bits DB1₁₁₋ₙₘ to DB12₁₁₋ₙₘ, as follows:

DB1₁₁₋ₙₘ: 1st bit of pixel driving data GD₁₁₋ₙₘ

DB2₁₁₋ₙₘ: 2nd bit of pixel driving data GD₁₁₋ₙₘ

DB3₁₁₋ₙₘ: 3rd bit of pixel driving data GD₁₁₋ₙₘ

DB4₁₁₋ₙₘ: 4th bit of pixel driving data GD₁₁₋ₙₘ

DB5₁₁₋ₙₘ: 5th bit of pixel driving data GD₁₁₋ₙₘ

DB6₁₁₋ₙₘ: 6th bit of pixel driving data GD₁₁₋ₙₘ

DB7₁₁₋ₙₘ: 7th bit of pixel driving data GD₁₁₋ₙₘ

DB8₁₁₋ₙₘ: 8th bit of pixel driving data GD₁₁₋ₙₘ

DB9₁₁₋ₙₘ: 9th bit of pixel driving data GD₁₁₋ₙₘ

DB10₁₁₋ₙₘ: 10th bit of pixel driving data GD₁₁₋ₙₘ

DB11₁₁₋ₙₘ: 11th bit of pixel driving data GD₁₁₋ₙₘ

DB12₁₁₋ₙₘ: 12th bit of pixel driving data GD₁₁₋ₙₘ

These bits DB1₁₁₋ₙₘ, DB2₁₁₋ₙₘ, . . . , DB12₁₁₋ₙₘ are then read sequentially one row at a time and supplied to the address driver 6, in response to read signals supplied by the driving control circuit 2.

The driving control circuit 2 generates a clock signal for the A/D converter 4 and write and read signals for the memory 5, synchronized with the horizontal sync signal H and vertical sync signal V.

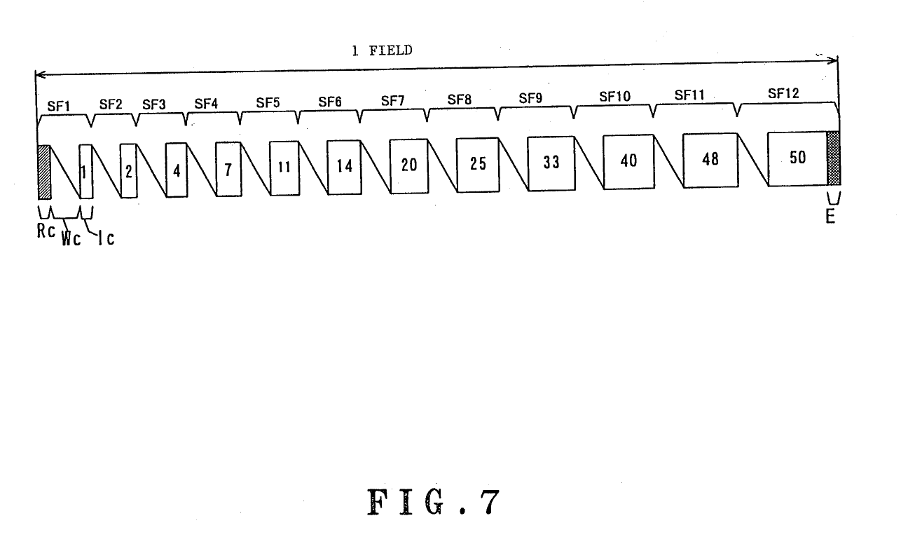

Also, the driving control circuit 2 supplies various timing signals to drive the PDP 10 to the address driver 6, first sustain driver 7, and second sustain driver 8, in accordance with the emission driving format shown in FIG. 7.

The emission driving format shown in FIG. 7 divides one field in an image signal into 12 subfields, namely SF1 to SF12, and performs driving of the PDP 10 by subfields. Here, each subfield comprises an address sequence Wc which sets each discharge cell of the PDP 10 to the “lit discharge cell state” or to the “extinguished discharge cell state”, based on the input image signal, and an emission sustain sequence Ic which causes only those discharge cells in the “lit discharge cell state” to emit light for a period (number of times) corresponding to the weighting of the subfield. However, a simultaneous reset sequence Rc which initializes to the “lit discharge cell state” all discharge cells of the PDP 10 is executed only in the leading subfield SF1, and an extinction sequence E is executed only for the final subfield SF12.

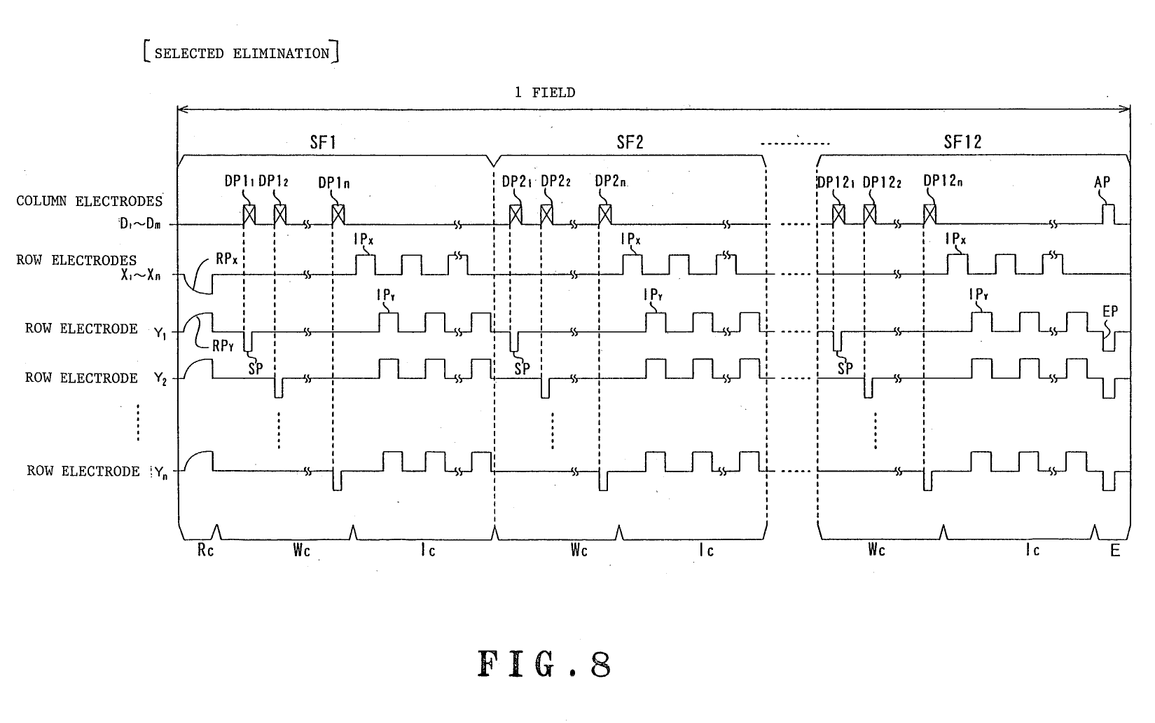

FIG. 8 illustrates the timing for application of various driving pulses applied to the row electrodes and column electrodes of the PDP 10 by the address driver 6, first sustain driver 7, and second sustain driver 8, according to the emission driving format shown in FIG. 7.

First, in the simultaneous reset sequence Rc for the subfield SF1, the first sustain driver 7 applies negative-polarity reset pulses RPₓ to the row electrodes X₁ to Xₙ, as shown in FIG. 8. Simultaneously with the application of the reset pulses RP_{X}, the second sustain driver 8 applies positive-polarity reset pulses RP_{Y} to the row electrodes Y₁ to Y₂, as shown in FIG. 8. All the discharge cells of the PDP 10 undergo reset discharge in response to application of these reset pulses RP_{X} and RP_{Y}, and a prescribed quantity of wall charge is formed uniformly within each of the discharge cells. By this means, all the discharge cells are initialized to the “lit discharge cell state”.

Next, in the address sequence Wc for each of the subfields, the address driver 6 generates pixel data pulses having a voltage corresponding to the logical level of the pixel driving data bits DB supplied from the memory 5. For example, when the logical level of the pixel driving data bit DB is “1”, the address driver 6 generates a high-voltage pixel data pulse, and when it is “0” generates a low-voltage (0 V) pixel data pulse. The address driver 6 applies a pixel data pulse group DP, comprising one row's (one display line's) worth of pixel data pulses, to the column electrodes D₁ to Dₘ. For example, in the address sequence Wc for the subfield SF1, first the portion corresponding to the first row (display line), that is, DB1₁₁₋₁ₘ, is extracted from the pixel driving data bits DB1₁₁₋ₙₘ, and a pixel data pulse group DP1₁, comprising m pixel data pulses corresponding to the logical levels of these bits DB1₁₁₋₁ₘ, is applied to the column electrodes D₁₋ₘ. Next, the bits DB1₂₁₋₂ₘ which are the portion corresponding to the second row (display line) of the pixel driving data bits DB1₁₁₋ₙₘ are extracted, and a pixel data pulse group DP1₂ comprising m pixel data pulses corresponding to the logical levels of these bits DB1₂₁₋₂ₘ is applied to the column electrodes D₁₋ₘ. In similar fashion, pixel data pulse groups DP1₃ to DP1ₙ for each row (display line) are applied in sequence to the column electrodes D₁ to Dₘ in the address sequence Wc for the subfield SF1.

In the address sequence Wc the second sustain driver 8 generates negative-polarity scan pulses SP as shown in FIG. 8, with the same timing as the timing for application of the above-described pixel data pulse groups DP, and applies the scan pulses SP sequentially to the row electrodes Y₁ to Yₙ. Here, discharge (selected elimination discharge) occurs only in those discharge cells at intersections between the row electrodes to which scan pulses SP are applied, and column electrodes to which high-voltage pixel data pulses are applied, and the wall charge remaining in these discharge cells is (selectively) eliminated (removed, erased). That is, each of the 1st through 12th bits in the pixel driving data GD determines whether selected elimination discharge is to be induced in the address sequence Wc in each of the subfields SF1 to SF12. Discharge cells which have been initialized to the “lit discharge cell state” in the simultaneous reset sequence Rc make a transition to the “extinguished discharge cell state” as a result of this selected elimination discharge. On the other hand, discharge cells in which the selected elimination discharge has not been induced are maintained in the state initialized in the simultaneous reset sequence Rc, that is, in the “lit discharge cell state”.

Next, in the emission sustain sequence Ic for each subfield, the first sustain driver 7 and the second sustain driver 8 alternately apply positive-polarity sustain pulses IP_{X} and IP_{Y} to the row electrodes X₁ to Xₙ and Y₁ to Yₙ, as shown in FIG. 8.

Here, the number of sustain pulses IP applied in the emission sustain sequence Ic is, for the respective subfields SF1 to SF12, as follows.

SF1: 1

SF2: 2

SF3: 4

SF4: 7

SF5: 11

SF6: 14

SF7: 20

SF8: 25

SF9: 33

SF10: 40

SF11: 48

SF12: 50

At this time, only those discharge cells in which wall charge remains without change, that is, only discharge cells set in the “lit discharge cell state” in the address sequence Wc, cause sustained discharge each time the sustain pulses IP_{X} and IP_{Y} are applied. Consequently, discharge cells set in the “lit discharge cell state” sustain the emission state accompanying sustain discharge for the number of discharges allocated to the respective subfields, as described above.

The elimination sequence E is executed only for the final subfield SF12. In this elimination sequence E, the address driver 6 generates and applies positive-polarity elimination pulses AP to the column electrodes D₁ to Dₘ₁ as shown in FIG. 8. Further, the second sustain driver 8 generates negative-polarity elimination pulses EP simultaneously with the timing of application of these elimination pulses AP, as shown in FIG. 8, and applies the elimination pulses EP to the row electrodes Y₁ to Yₙ. By means of the simultaneous application of these elimination pulses AP and EP, elimination discharge is induced in all the discharge cells in the PDP 10, and the wall charge remaining in all the discharge cells is annihilated. By means of this elimination discharge, all the discharge cells in the PDP 10 enter the “extinguished discharge cell state”.

Hence through the driving shown in FIGS. 7 and 8, only those discharge cells set in the “lit discharge cell state” in the address sequence Wc within each subfield repeat emission the number of times described above in the immediately succeeding emission sustain sequence Ic.

Whether each discharge cell is set in the “lit discharge cell state” or in the “extinguished discharge cell state” is determined by the pixel driving data GD, as shown in FIG. 6. That is, when a bit in the pixel driving data GD is at logical level “1”, selected elimination discharge is induced in the address sequence Wc of the subfield corresponding to the digit position for that bit (bit place), and the discharge cell is set in the “extinguished discharge cell state”. On the other hand, when the logical level for the bit is “0”, the selected elimination discharge is not induced, and the current state is maintained. That is, discharge cells which until immediately before this address sequence Wc were in the “extinguished discharge cell state” are maintained in the “extinguished discharge cell state”, and discharge cells which were in the “lit discharge cell state” are maintained without change in the “lit discharge cell state”. Here, as a result of using the pixel driving data GD shown in FIG. 6, it is possible for a discharge cell to make a transition from the “extinguished discharge cell state” to the “lit discharge cell state” within subfields SF1 to SF12 only during the simultaneous reset sequence Rc of the leading subfield SF1. Hence after the end of the simultaneous reset sequence Rc, a discharge cell which has once made the transition to the “extinguished discharge cell state” in any one of the address sequences Wc in subfields SF1 to SF12 does not again make a transition to the “lit discharge cell state” within that subfield. Consequently, if the pixel driving data GD shown in FIG. 6 is utilized, each discharge cell is in the “lit discharge cell state” in a period from the beginning of the first field until the inducement of selected elimination discharge in the subfield indicated by the black circle in FIG. 6. During the emission sustain sequence Ic existing during this period for each subfield, indicated by a white circle, emission occurs the number of times described above. Here, the brightness of the grayscale is represented by the total number of emissions executed in each of the subfields SF1 to SF12 within one field.

In other words, by use of the pixel driving data GD having 13 data patterns as shown in FIG. 6, the intermediate brightnesses of 13 grayscales can be represented, as follows:

0:1:3:7:14:25:39:59:84:117:157:205:255

The pixel data obtained based on the image signal is 8 bits; 256 halftones can be made. Multi-grayscale processing is performed by the multi-grayscale processing circuit 33 in order to allow the driving scheme utilized in representing (expressing) the above-mentioned 13 intermediate brightnesses to also represent approximately 256 grayscales' worth of halftones in a pseudo fashion.

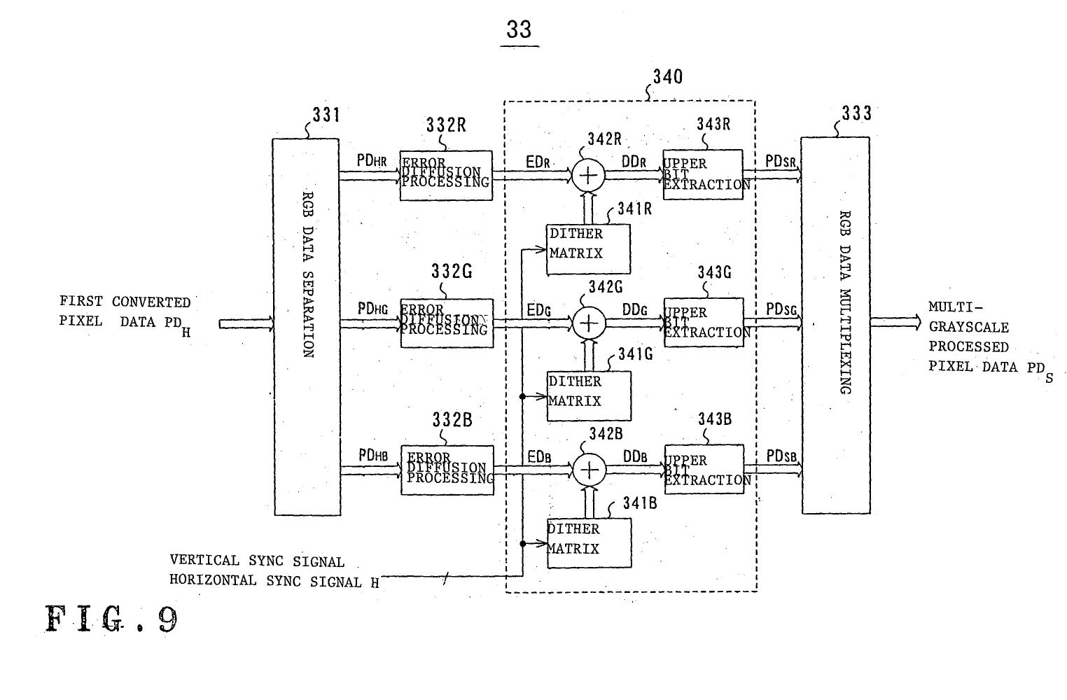

FIG. 9 shows the internal configuration of this multi-grayscale processing circuit 33.

As shown in FIG. 9, the multi-grayscale processing circuit 33 includes an RGB data separation circuit 331, error diffusion processing circuit 332, RGB data multiplexing circuit 333, and dither processing circuit 340.

The RGB data separation circuit 331 separates and extracts data for red emission, data for green emission, and data for blue emission from the series of first converted pixel data PD_{H} supplied by the first data conversion circuit 32. Here, the RGB data separation circuit 331 supplies data for red emission to the error diffusion processing circuit 332R as red pixel data PD_{HR}. Likewise, the RGB data separation circuit 331 supplies data for green emission to the error diffusion processing circuit 332G as green pixel data PD_{HG}, and supplies data for blue emission to the error diffusion processing circuit 332B as blue pixel data PD_{HB}.

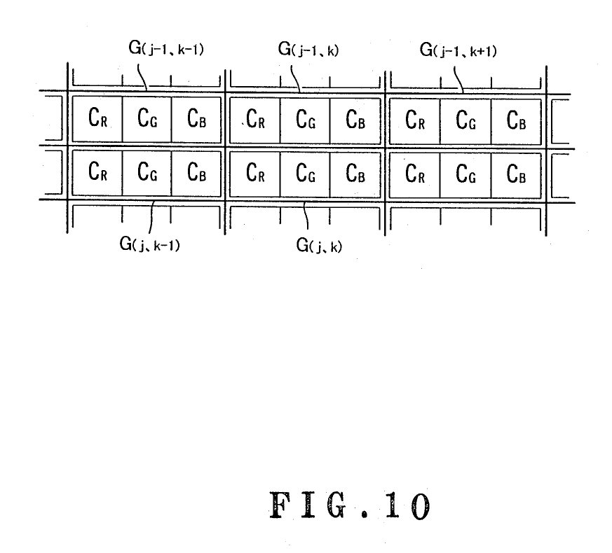

The error diffusion processing circuit 332R first extracts red pixel data corresponding to red discharge cells C_{R} at each of the pixels G(j,k), G(j,k−1), G(j−1,k−1), G(j−1,k), and G(j−1,k+1) in the PDP 10, as shown in FIG. 10, from the series of red pixel data PD_{HR} supplied by the RGB data separation circuit 331. Next, taking as the lowest bit the digit-carry bit (of single bit worth) obtained when weighting and adding the respective lower two bits of the red pixel data corresponding to these pixels, this lowest bit is added to the upper 7 bits of the red pixel data corresponding to the red discharge cell C_{R} of the pixel G(j,k), to obtain 8-bit data. The error diffusion processing circuit 332R supplies these 8 data bits to the dither processing circuit 340 as error diffusion-processed pixel data ED_{R}. The error diffusion processing circuit 332G first extracts green pixel data corresponding to green discharge cells C_{G} at each of the pixels G(j,k), G(j,k−1), G(j−1,k−1), G(j−1,k), and G(j−1,k+1) in the PDP 10, as shown in FIG. 10, from the series of green pixel data PD_{HG} supplied by the RGB data separation circuit 331. Next, taking as the lowest bit the digit-carry bit obtained when weighting and adding the respective lower two bits of the green pixel data corresponding to these pixels, the lowest bit is are added to the upper 7 bits of the green pixel data corresponding to the green discharge cell C_{G} of the pixel G(j,k), to obtain 8-bit data. The error diffusion processing circuit 332G supplies these 8 data bits to the dither processing circuit 340 as error diffusion-processed pixel data ED_{G}. The error diffusion processing circuit 332B first extracts blue pixel data corresponding to blue discharge cells C_{B} at each of the pixels G(j,k), G(j,k−1), G(j−1,k−1), G(j−1,k), and G(j−1,k+1) in the PDP 10, as shown in FIG. 10, from the series of blue pixel data PD_{HB} supplied by the RGB data separation circuit 331. Next, taking as the lowest bit the digit-carry bit obtained when weighting and adding the respective lower two bits of the blue pixel data corresponding to these pixels, the lowest bit is added to the upper 7 bits of the blue pixel data corresponding to the blue discharge cell C_{B} of the pixel G(j,k), to obtain 8-bit data. The error diffusion processing circuit 332B supplies the 8-bit data to the dither processing circuit 340 as error diffusion-processed pixel data ED_{B}.

In other words, the error diffusion processing circuit 332 reflects, in the pixel data corresponding to the pixel G(j,k), the result of weighting and adding the lowest data bits of the pixels G(j,k−1), G(j−1,k+1), G(j−1,k), and G(j−1,k−1) surrounding the pixel G(j,k). Through this operation, the brightness component corresponding to the lowest two bits for the pixel G(j,k) are approximately (in a pseudo manner) represented by the peripheral pixels.

The dither processing circuit 340 includes dither matrix circuits (341R, 341G and 341B), adders (342R, 342G and 342B), and upper bit extraction circuits (343R, 343G and 343B).

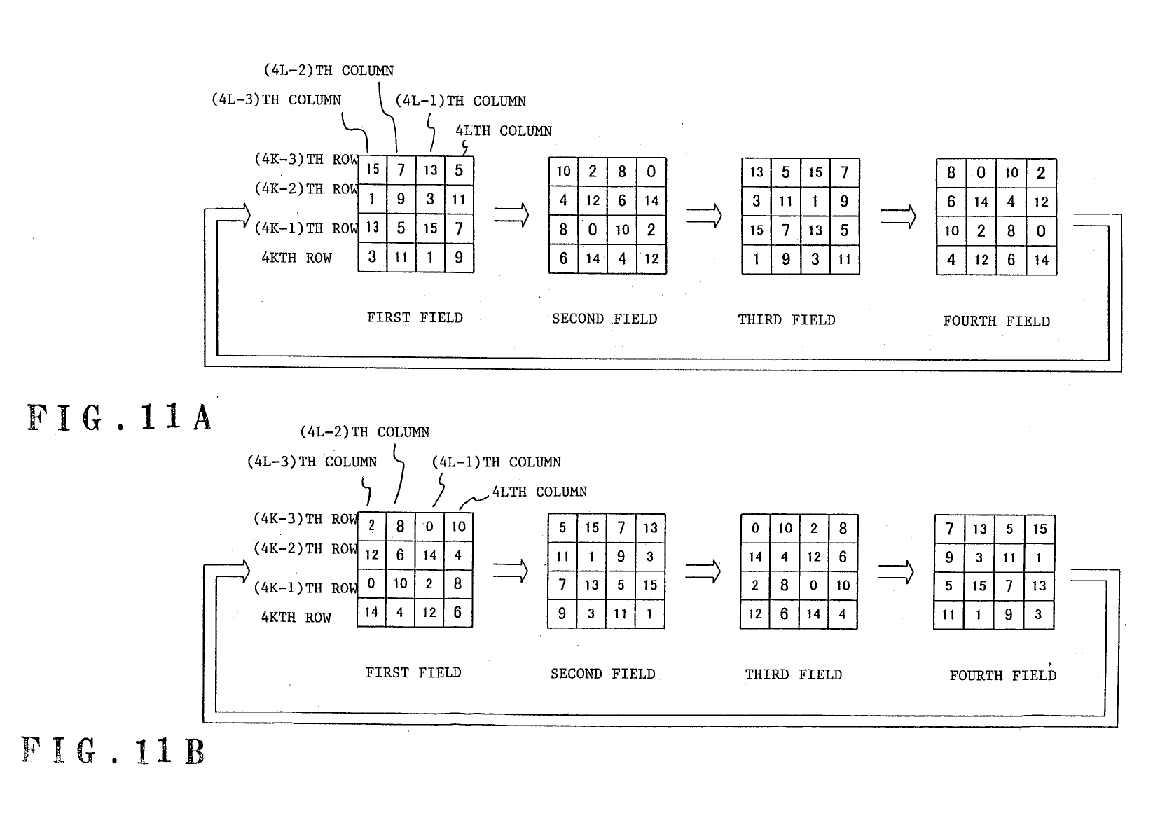

The dither matrix circuits 341R and 341B generate 4-bit dither coefficients able to represent, for each 4-row by 4-column pixel group of the PDP 10, “0” to “15” corresponding to sixteen pixel positions within the pixel group, as shown in FIG. 11A. That is, as shown in FIG. 11A, the dither matrix circuits 341R and 341B generate dither coefficients “15”, “7”, “13”, “5” for pixels belonging to the (4L-3)th column, (4L-2)th column, (4L-1)th column, and the 4Lth column in the (4K-3) th row of the PDP 10, in the first field.

Also, in this first field the dither matrix circuits 341R and 341B generate dither coefficients “1”, “9”, “3”, “11” for pixels belonging to the (4L-3)th column, (4L-2)th column, (4L-1)th column, and the 4Lth column in the (4K-2)th row of the PDP 10.

Likewise, in this first field the dither matrix circuits 341R and 341B generate dither coefficients “13”, “5”, “15”, “7” corresponding to pixels belonging to the (4L-3)th column, (4L-2)th column, (4L-1)th column, and the 4Lth column in the (4K-1)th row of the PDP 10.

In this first field the dither matrix circuits 341R and 341B generate dither coefficients “3”, “11”, “1”, “9” corresponding to pixels belonging to the (4L-3)th column, (4L-2)th column, (4L-1)th column, and the 4Lth column in the 4Kth row of the PDP 10.

K represents a natural number from 1 to n/4, and L represents a natural number from 1 to m/4.

In the second field, the dither matrix circuits 341R and 341B generate dither coefficients “10”, “2”, “8”, “0” corresponding to pixels belonging to the (4L-3)th column, (4L-2)th column, (4L-1)th column, and the 4Lth column in the (4K-3)th row of the PDP 10.

In this second field the dither matrix circuits 341R and 341B generate dither coefficients “2”, “12”, “6”, “14” corresponding to pixels belonging to the (4L-3)th column, (4L-2)th column, (4L-1)th column, and the 4Lth column in the (4K-2)th row of the PDP 10.

In this second field the dither matrix circuits 341R and 341B generate dither coefficients “8”, “0”, “10”, “2” corresponding to pixels belonging to the (4L-3)th column, (4L-2)th column, (4L-1)th column, and the 4Lth column in the (4K-1)th row of the PDP 10.

In this second field the dither matrix circuits 341R and 341B generate dither coefficients “6”, “14”, “4”, “12” corresponding to pixels belonging to the (4L-3)th column, (4L-2)th column, (4L-1)th column, and the 4Lth column in the 4Kth row of the PDP 10.

In the third field, the dither matrix circuits 341R and 341B generate dither coefficients “13”, “5”, “15”, “7” corresponding to pixels belonging to the (4L-3)th column, (4L-2)th column, (4L-1)th column, and the 4Lth column in the (4K-3)th row of the PDP 10.

In this third field the dither matrix circuits 341R and 341B generate dither coefficients “3”, “11”, “1”, “9” corresponding to pixels belonging to the (4L-3)th column, (4L-2)th column, (4L-1)th column, and the 4Lth column in the (4K-2)th row of the PDP 10.

In this third field the dither matrix circuits 341R and 341B generate dither coefficients “15”, “7”, “13”, “5” corresponding to pixels belonging to the (4L-3)th column, (4L-2)th column, (4L-1)th column, and the 4Lth column in the (4K-1)th row of the PDP 10.

In this third field the dither matrix circuits 341R and 341B generate dither coefficients “1”, “9”, “3”, “11” corresponding to pixels belonging to the (4L-3)th column, (4L-2)th column, (4L-1)th column, and the 4Lth column in the 4Kth row of the PDP 10.

In the fourth field, the dither matrix circuits 341R and 341B generate dither coefficients “8”, “0”, “10”, “2” corresponding to pixels belonging to the (4L-3)th column, (4L-2)th column, (4L-1)th column, and the 4Lth column in the (4K-3)th row of the PDP 10.

In this fourth field the dither matrix circuits 341R and 341B generate dither coefficients “6”, “14”, “4”, “12” corresponding to pixels belonging to the (4L-3)th column, (4L-2)th column, (4L-1)th column, and the 4Lth column in the (4K-2)th row of the PDP 10.

In this fourth field the dither matrix circuits 341R and 341B generate dither coefficients “10”, “2”, “8”, “0” corresponding to pixels belonging to the (4L-3)th column, (4L-2)th column, (4L-1)th column, and the 4Lth column in the (4K-1)th row of the PDP 10.

In this fourth field the dither matrix circuits 341R and 341B generate dither coefficients “4”, “12”, “6”, “14” corresponding to pixels belonging to the (4L-3)th column, (4L-2)th column, (4L-1)th column, and the 4Lth column in the 4Kth row of the PDP 10.

The dither matrix circuits 341R and 341B repeatedly execute a series of operations to generate dither coefficients in the first through fourth fields, as shown in FIG. 11A.

The dither matrix circuit 341R supplies the generated dither coefficients to the adder 342R with timing matched to the error diffusion-processed pixel data ED_{R} supplied corresponding to the red discharge cells within each pixel in a 4-row by 4-column pixel group. The adder 342R adds the error diffusion-processed pixel data ED_{R} and the dither coefficients shown in FIG. 11A generated by the dither matrix circuit 341R, and supplies the resulting dither-added red pixel data DD_{R} to the upper bit extraction circuit 343R. The upper bit extraction circuit 343R extracts the upper 4 bits from the dither-added red pixel data DD_{R}, and supplies this upper 4 bits to the RGB data multiplexing circuit 333 as multi-grayscale red pixel data PD_{SR}.

The dither matrix circuit 341B supplies the generated dither coefficients to the adder 342B with timing matched to the error diffusion-processed pixel data ED_{B} supplied corresponding to the blue discharge cells within each pixel in a 4-row by 4-column pixel group. The adder 342B adds the error diffusion-processed pixel data ED_{B} and the dither coefficients shown in FIG. 11A generated by the dither matrix circuit 341B, and supplies the resulting dither-added blue pixel data DD_{B} to the upper bit extraction circuit 343B. The upper bit extraction circuit 343B extracts the upper 4 bits from the dither-added blue pixel data DD_{B}, and supplies this upper 4 bits to the RGB data multiplexing circuit 333 as multi-grayscale blue pixel data PD_{SB}.

On the other hand, the dither matrix circuit 341G generates dither coefficients as shown in FIG. 11B, which are different from those of the dither matrix circuits 341R and 341B. That is, as shown in FIG. 11B, in the first field the dither matrix circuit 341G generates dither coefficients “2”, “8”, “0”, “10” for pixels belonging to the (4L-3)th column, (4L-2)th column, (4L-1)th column, and the 4Lth column in the (4K-3)th row of the PDP 10.

In this first field the dither matrix circuit 341G generates dither coefficients “12”, “6”, “14”, “4” for pixels belonging to the (4L-3)th column, (4L-2)th column, (4L-1)th column, and the 4Lth column in the (4K-2)th row of the PDP 10.

In this first field the dither matrix circuit 341G generates dither coefficients “0”, “10”, “2”, “8” for pixels belonging to the (4L-3)th column, (4L-2)th column, (4L-1)th column, and the 4Lth column in the (4K-1)th row of the PDP 10.

In this first field the dither matrix circuit 341G generates dither coefficients “14”, “14”, “12”, “6” corresponding to pixels belonging to the (4L-3)th column, (4L-2)th column, (4L-1)th column, and the 4Lth column in the 4Kth row of the PDP 10.

In the second field the dither matrix circuit 341G generates dither coefficients “5”, “15”, “7”, “13” corresponding to pixels belonging to the (4L-3)th column, (4L-2)th column, (4L-1)th column, and the 4Lth column in the (4K-3)th row of the PDP 10.

In this second field the dither matrix circuit 341G generates dither coefficients “11”, “1”, “9”, “3” corresponding to pixels belonging to the (4L-3)th column, (4L-2)th column, (4L-1)th column, and the 4Lth column in the (4K-2)th row of the PDP 10.

In this second field the dither matrix circuit 341G generates dither coefficients “7”, “13”, “5”, “15” corresponding to pixels belonging to the (4L-3)th column, (4L-2)th column, (4L-1)th column, and the 4Lth column in the (4K-1)th row of the PDP 10.

In this second field the dither matrix circuit 341G generates dither coefficients “9”, “3”, “11”, “1” corresponding to pixels belonging to the (4L-3)th column, (4L-2)th column, (4L-1)th column, and the 4Lth column in the 4Kth row of the PDP 10.

In the third field the dither matrix circuit 341G generates dither coefficients “0”, “10”, “2”, “8” corresponding to pixels belonging to the (4L-3)th column, (4L-2)th column, (4L-1)th column, and the 4Lth column in the (4K-3)th row of the PDP 10.

In this third field the dither matrix circuit 341G generates dither coefficients “14”, “4”, “12”, “6” corresponding to pixels belonging to the (4L-3)th column, (4L-2)th column, (4L-1)th column, and the 4Lth column in the (4K-2)th row of the PDP 10.

In this third field the dither matrix circuit 341G generates dither coefficients “2”, “8”, “0”, “0” corresponding to pixels belonging to the (4L-3)th column, (4L-2)th column, (4L-1)th column, and the 4Lth column in the (4K-1)th row of the PDP 10.

In this third field the dither matrix circuit 341G generates dither coefficients “12”, “6”, “14”, “4” corresponding to pixels belonging to the (4L-3)th column, (4L-2)th column, (4L-1)th column, and the 4Lth column in the 4Kth row of the PDP 10.

In the fourth field the dither matrix circuit 341G generates dither coefficients “7”, “13”, “5”, “15” corresponding to pixels belonging to the (4L-3)th column, (4L-2)th column, (4L-1)th column, and the 4Lth column in the (4K-3)th row of the PDP 10.

In this fourth field the dither matrix circuit 341G generates dither coefficients “9”, “3”, “11”, “1” corresponding to pixels belonging to the (4L-3)th column, (4L-2)th column, (4L-1)th column, and the 4Lth column in the (4K-2)th row of the PDP 10.

In this fourth field the dither matrix circuit 341G generates dither coefficients “5”, “15”, “7”, “13” corresponding to pixels belonging to the (4L-3)th column, (4L-2)th column, (4L-1)th column, and the 4Lth column in the (4K-1)th row of the PDP 10.

In this fourth field the dither matrix circuit 341G generates dither coefficients “11”, “1”, “9”, “3” corresponding to pixels belonging to the (4L-3)th column, (4L-2)th column, (4L-1)th column, and the 4Lth column in the 4Kth row of the PDP 10.

The dither matrix circuit 341G repeatedly execute a series of operations to generate dither coefficients in the first through fourth fields, as shown in FIG. 11B. Also, the dither matrix circuit 341G supplies the generated dither coefficients to the adder 342G with timing matched to the error diffusion-processed pixel data ED_{G} supplied corresponding to the green discharge cells within each pixel in a 4-row by 4-column pixel group. The adder 342G adds the error diffusion-processed pixel data ED_{G} and the dither coefficients shown in FIG. 11B generated by the dither matrix circuit 341G, and supplies the resulting dither-added green pixel data DD_{G} to the upper bit extraction circuit 343G. The upper bit extraction circuit 343G extracts the upper 4 bits from the dither-added green pixel data DD_{G}, and supplies this upper 4 bits to the RGB data multiplexing circuit 333 as multi-grayscale green pixel data PD_{SG}.

The RGB data multiplexing circuit 333 performs time-division multiplexing of the multi-grayscale red pixel data PD_{SR}, multi-grayscale green pixel data PD_{SG}, and multi-grayscale blue pixel data PD_{SB}, in order, and outputs the resulting data train to the second data conversion circuit 34 as the multi-grayscale processed pixel data PD_{S}, as shown in FIG. 2.

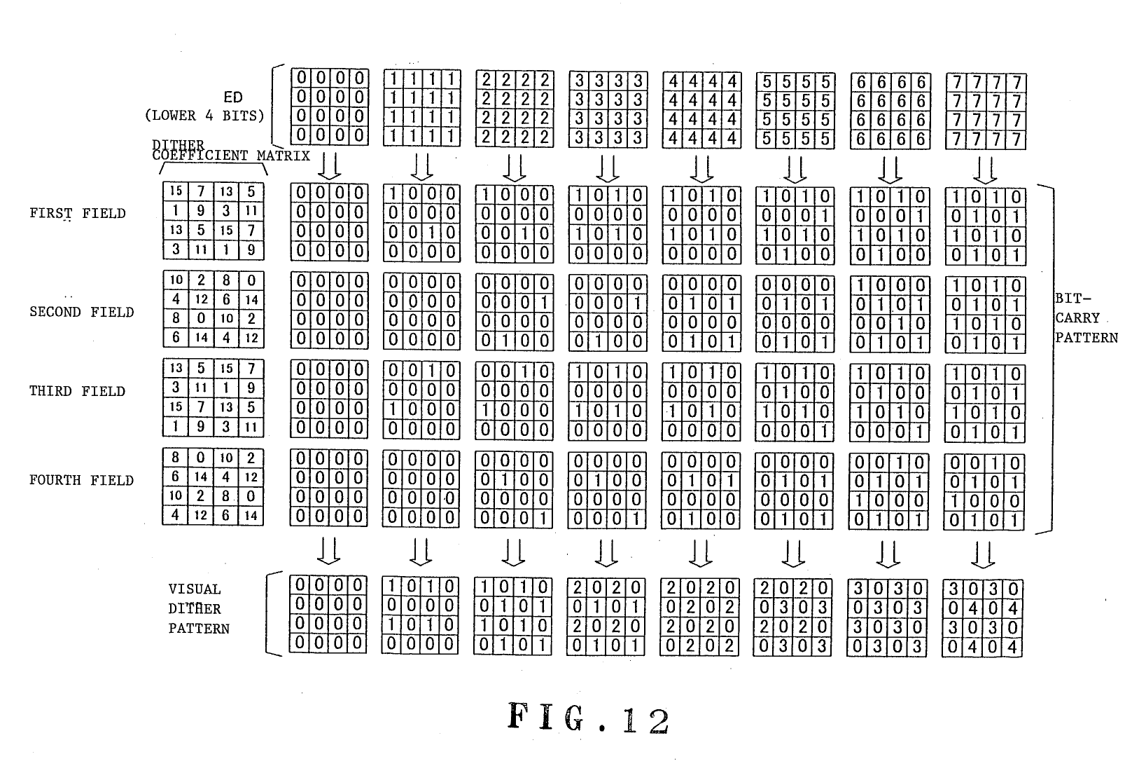

Thus in dither processing of error diffusion-processed pixel data ED_{R} which is responsible for red light emission and error diffusion-processed pixel data ED_{B} which is responsible for blue light emission, the dither processing circuit 340 adds 4-bit dither coefficients from “0” to “15”, as shown in FIG. 11A, to the lower 4 bits of the error diffusion-processed pixel data ED_{R} and ED_{B}. Here, digit carrying which occurs when the 4-bit dither coefficients are added to the lower 4 bits of the error diffusion-processed pixel data ED_{R} (or ED_{B}) takes a form like that shown in FIG. 12. It should be noted in FIG. 12 that only eight cases are excerpted; the first case shows where the lower 4 bits are all “0” for all of the 16 error diffusion-processed pixel data ED corresponding to 16 pixels in a 4-row by 4-column pixel group, the second case shows where the lower 4 bits are all “1”, the third case shows where the lower 4 bits are all “2”, the fourth case shows where the lower 4 bits are all “3 ” the fifth case shows where the lower 4 bits are all “4”, the sixth case shows where the lower 4 bits are all “5”, the seventh case shows where the lower 4 bits are all “6”, and the eighth case shows where the lower 4 bits are all “7”. Carrying is reflected in the upper 4 bits of both the dither-added red pixel data DD_{R} and the dither-added blue pixel data DD_{B}. Hence when a 4-row by 4-column pixel group is handled as one display unit, intermediate brightnesses equivalent to 7 bits can be represented (expressed), based on the 4-bit multi-grayscale red pixel data PD_{SR} and multi-grayscale blue pixel data PD_{SB}. Here, the patterns of dither coefficients added within 4-row by 4-column pixel groups differ for each of the first to fourth fields, so that the digit carry pattern makes a transition from the first field to the fourth field, as shown in FIG. 12. By repeatedly executing the carry pattern transition between the first field and the fourth field, a dither pattern is visually represented on the screen of the PDP 10, as shown in FIG. 12.

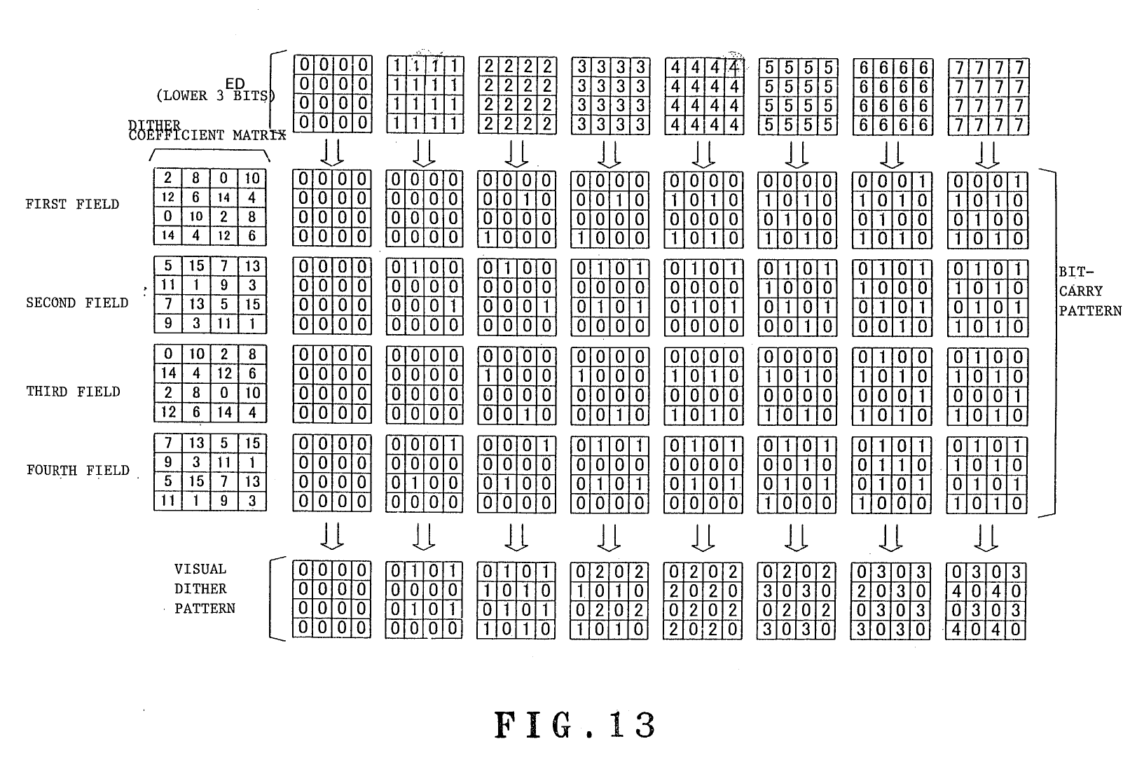

On the other hand, in dither processing of error diffusion-processed pixel data responsible for green light emission ED_{G}, as shown in FIG. 11B, 4-bit dither coefficients from “0” to “15” are generated having a matrix pattern differing from that of FIG. 11A, and are added to the lower 4 bits of the error diffusion-processed pixel data ED_{G}. Here, carry bits resulting when the 4-bit dither coefficients are added to the lower 4 bits of the error diffusion-processed pixel data ED_{G} take the form shown in FIG. 13, and the result of this carrying is reflected in the upper 4 bits of the dither-added green pixel data DD_{G}. Hence when handling a 4-row by 4-column pixel group as one display unit, intermediate brightnesses equivalent to 7 bits can be represented based on the 4-bit multi-grayscale green pixel data PD_{G}. Here, the pattern of the dither coefficients added in a 4-row by 4-column pixel group is different for each of the first to the fourth fields, so that the bit-carry pattern also changes from the first to the fourth fields, as shown in FIG. 13. Thus by repeatedly executing the carry pattern change from the first to the fourth fields, a dither pattern like that shown in FIG. 13 is visually represented on the screen of the PDP 10. Here, the dither pattern which appears visually on the screen is different from that shown in FIG. 12. That is, as shown in FIG. 10, the dither pattern perceived as a result of emission by green discharge cells C_{G} formed in each pixel (FIG. 13) is different from the dither pattern perceived as a result of emission by red discharge cells C_{R} and blue discharge cells C_{B} (FIG. 12). Consequently different dither patterns are intermixed within a single screen, as shown in FIG. 12 and FIG. 13, and no specific dither pattern is perceived.

This application is based on Japanese patent application No. 2001-161994, the entire disclosure of which is incorporated herein by reference.

What is claimed is:

1. A display device for displaying images in accordance with image signals on a display screen, in which display screen pixels including a plurality of display cells with different emission colors are arranged in a matrix fashion, the display device comprising:
a converting unit for converting said image signals into pixel data such that the pixel data correspond to the respective display cells;
a dither coefficient generation unit for generating dither coefficients such that the dither coefficients correspond to the respective display cells within said pixels;
an adding unit for adding said dither coefficients to said pixel data to obtain dither-added pixel data; and
a display drive for causing said display cells to emit light in accordance with said dither-added pixel data, and
wherein values of dither coefficients corresponding to display cells used for emission of at least one color within said pixels are different from values of dither coefficients corresponding to other display cells used for emission of other colors within said pixels.

2. The display device according to claim 1, wherein said display cells within said pixels include red display cells which emit red light, green display cells which emit green light, and blue display cells which emit blue light, and values of dither coefficients corresponding to said green display cells are different from values of said dither coefficients corresponding to said red display cells and said blue display cells.

3. The display device according to claim 1, wherein the dither coefficient generation unit modifies the values of the dither coefficients at each field period of said image signal.

4. The display device according to claim 1, wherein the dither coefficient generation unit generates the dither coefficients such that the dither coefficients correspond to all pixel positions in a matrix of the pixels arranged in N rows by M columns on said display screen.

5. A display panel driving method of driving a display panel, in which pixels including a plurality of display cells with different emission colors are arranged in a matrix fashion, in response to image signals, comprising the steps of:
A) converting said image signals into pixel data such that each of the pixel data corresponds to each of said display cells;
B) generating dither coefficients such that each of the dither coefficients corresponds to each of said display cells within said pixels;
C) adding said dither coefficients to said pixel data respectively to obtain dither-added pixel data; and
D) causing said display cells to emit light in accordance with said dither-added pixel data, and
wherein values of dither coefficients corresponding to display cells used for emission of at least one color within said pixels are different from values of other dither coefficients corresponding to other display cells used for emission of other emission colors within said pixels.

6. The display panel driving method according to claim 5, wherein said display cells within said pixels include red display cells which emit red light, green display cells which emit green light, and blue display cells which emit blue light, and values of dither coefficients corresponding to said green display cells are different from values of dither coefficients corresponding to said red display cells and said blue display cells.

7. The display panel driving method according to claim 5, wherein Step B generates the dither coefficients while modifying the values of the dither coefficients at each field period of said image signal.

8. The display panel driving method according to claim 5, wherein Step B generates the dither coefficients such that each of the dither coefficients corresponds to each pixel position in a matrix of said pixels arranged in N rows by M columns on the screen of said display panel.
